(19) United States
(12) Patent Application Publication
(10) Pub. No.: US 2011/0119924 A1
(43) Pub. Date: May 26, 2011

(54) Stetho-Tool

(75) Inventor: Avraham Goldstein, Flushing, NY (US)

(73) Assignee: MAGENAV, INC., Flushing, NY (US)

(21) Appl. No.: 12/950,982

(22) Filed: Nov. 19, 2010

Related U.S. Application Data
(60) Provisional application No. 61/281,540, filed on Nov. 20, 2009.

(51) Int. Cl. B26B 11/00

(52) U.S. Cl. 30/123

(57) ABSTRACT

A device allows users to have a penlight and shears/scissors handy for medical procedures. The device may be detachable from a holster which can be secured to a stethoscope tube. The penlight and shears may be a formed as a single unit, held by the holster.

### CROSS-REFERENCE TO RELATED APPLICATIONS

This application claims the benefit of priority to U.S. Provisional patent application No. 61/281,540, filed Nov. 20, 2009, which is herein incorporated by reference.

### BACKGROUND OF THE INVENTION

The present invention relates to a medical device and, more particularly, to a device that combines a penlight and scissor. The device is adapted to fit into a holster that may be secured to a stethoscope tube.

There are several tools consistently utilized in the field of emergency medicine to rapidly and accurately assess patients. Many medical professionals carry their stethoscope about their necks. However, other often used tools may be less readily accessible. Penlights are often used to assess a patient's pupil reactivity and shears/scissors are often used to cut away a patient's clothes, shoelaces, belt, bandages and the like. Penlights and shears, however, are typically not carried by medical professionals and, when needed, may be difficult to find.

As can be seen, there is a need for device that combines a penlight and shears that may be secured to a stethoscope tube for easy access.

### SUMMARY OF THE INVENTION

In one aspect of the present invention, a tool comprises a penlight; shears attached to the penlight; a holster for removably holding the penlight and shears; a strap adapted to secure the holster to a stethoscope.

In another aspect of the present invention, a penlight/shears combination tool comprises a penlight/shears combination unit, the combination unit including a penlight, a first blade of shears attached to the penlight, and a second blade of shears pivotably attached to the penlight; a holster for removably securing the penlight/shears combination unit; a strap adapted to secure the holster to a stethoscope, wherein the strap has a slip resistant material on at least a portion of an inside surface thereof.

In a further aspect of the present invention, a medical tool comprises a stethoscope; a holster removably attached to a tube of the stethoscope; a penlight/shears combination unit removably attached to the holster, wherein the penlight/shears combination unit includes a penlight, a first blade of shears attached to the penlight, and a second blade of shears pivotably attached to the penlight.

These and other features, aspects and advantages of the present invention will become better understood with reference to the following drawings, description and claims.

### BRIEF DESCRIPTION OF THE DRAWINGS

FIG. 1 is a perspective view of a stethoscope having a stetho-tool attached thereto;

FIG. 2 is a perspective view of a penlight/shears tool (stetho-tool) according to an exemplary embodiment of the present invention;

FIG. 3 is a perspective view of the penlight/shears tool of FIG. 2 with the shears in a closed position;

FIG. 5 is a perspective view of the penlight/shears tool of FIG. 2 positioned in a holster that is adapted to be attached to a stethoscope; and

FIG. 5 is a perspective view of the holster of FIG. 4 with the penlight/shears tool removed therefrom.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a device that allows users to have a penlight and shears/scissors handy for medical procedures. The device may be detachable from a holster which can be secured to a stethoscope tube.

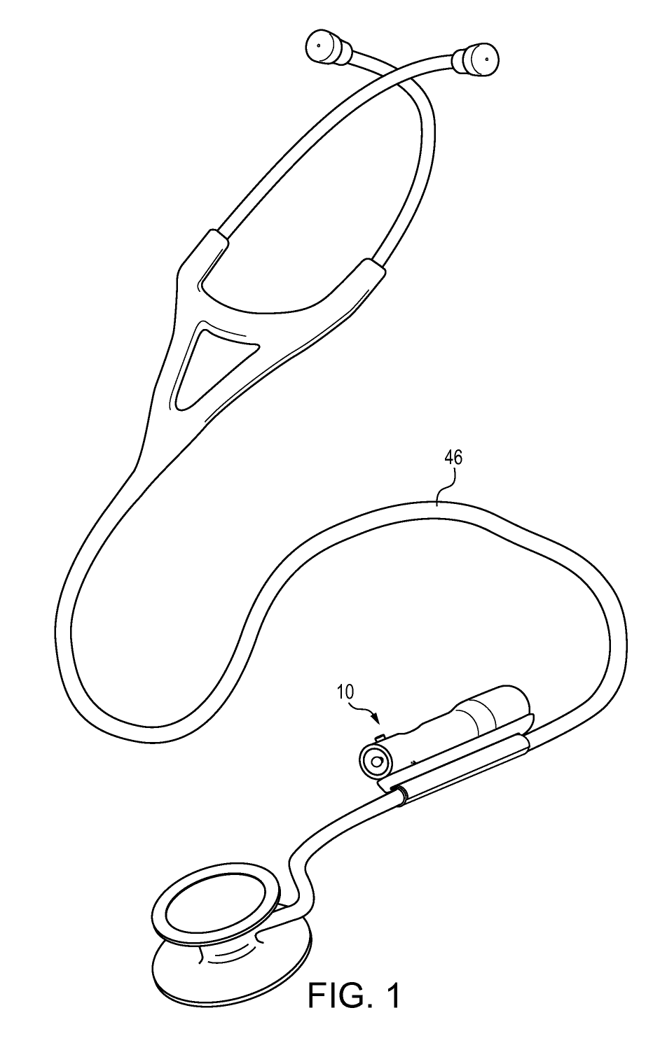

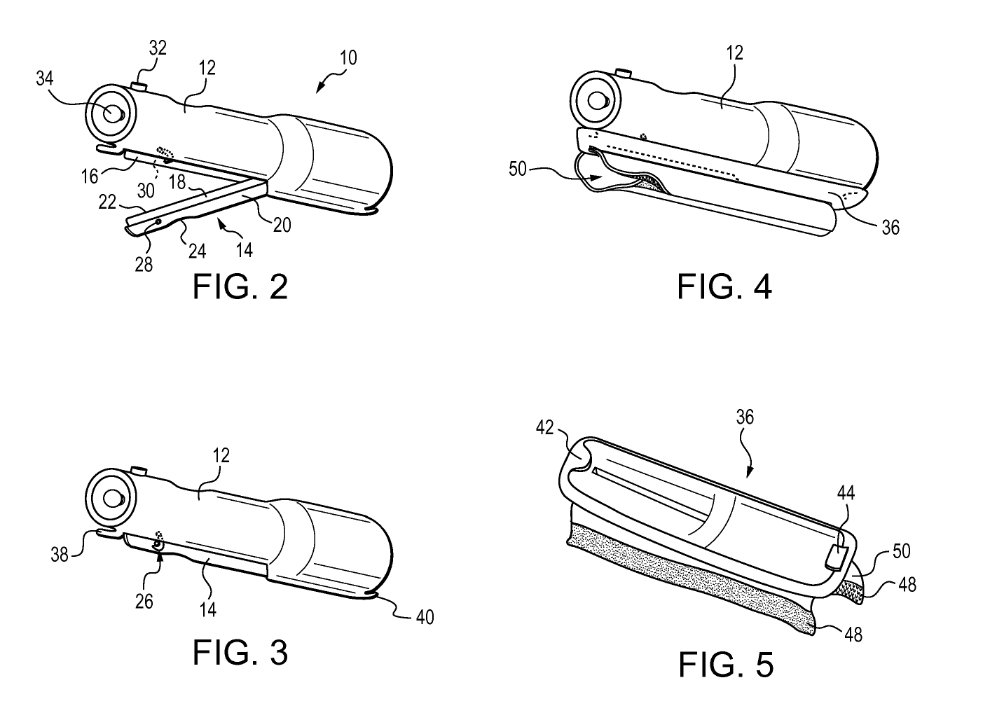

Referring to FIGS. 1 through 5, a penlight/shear tool 10 may include a penlight 12 with shears 14. The shears 14 may include a first blade 16 integrally formed into the penlight 12. A second blade 18 of the shears 14 may pivot from the penlight 12. The first blade 16 and the second blade 18 may interact, via the pivoting action of the second blade 18, to create a cutting tool. In some embodiments, the first and second blades 16, 18 may be smooth. In other embodiments, the first and second blades 16, 18 may be serrated. The second blade 18 may include a pressing surface 20 opposite a cutting surface 22 of the second blade 18. The pressing surface 20 may provide a location for a user to comfortably depress the second blade 18 onto the first blade 16. An indent 24 may be provided in the pressing surface 20.

The shears 14 may include a means for resiliently pushing open the second blade 18 from the first blade 16. For example, an internal spring may be provided to normally keep the blades 16, 18 separated. A lock 26 may be provided for locking the second blade 18 next to the first blade 16 (in a configuration similar to closed scissors, see FIG. 3). The lock 26 may be any mechanism known in the art. For example, the lock 26 may include a hole 28 in the second blade 18 that may receive a pin 30.

The tool 10 may include a push button 32 for turning on the penlight 12. Typically, the push button 32 will be a momentarily on push button, wherein the penlight 12 is lit only during the time that the push button 32 is depressed. The tool 10 may include a battery (not shown) for powering the penlight 12. The battery may be, for example, a replaceable battery. In some embodiments, the penlight 12 is powered by 1 or 2 size-AA batteries. The penlight 12 may include a lamp 34. The lamp 34 may be any known lamp that may light by the power source in the penlight 34. In some embodiments, the lamp 34 may be a light emitting diode (LED).

The tool 10 may be adapted to be secured in a holster 36. In some embodiments, the tool 10 may include front and rear tabs 38, 40 that may fit into slots 42, 44 of the holster 36. Other attachment means for removably attaching the tool 10 to the holster 36 may be within the scope of the present invention. In some embodiments, the tool 10 may fit into the holster 36 with the shears 14 being disposed between the tool 10 and the holster 36.

The holster 36 may include an attachment strap 38 for attaching the holster 36 to a stethoscope 46. In some embodiments, the attachment strap 38 may fit into a slot in the holster 36. In other embodiments, a separate attachment device may secure the attachment strap 38 to the holster 36. The attachment strap 38 may have two ends 48 descending from the holster 38. The ends may attach together by known methods. For example, the ends may attach together with a hook and loop type fastener, such as Velcro®. An inside portion 50 of the attachment strap 38 may be formed with a non-slip material, such as a thin rubber material. This non-slip material may help secure the holster 36 to the stethoscope 46 and prevent the holster 36 from sliding on the tubing of the stethoscope 46.

To use the tool 10, the holster 36 may be secured, with the attachment strap 38, to the tubing of the stethoscope 46. The tool 10 may be removably secured to the holster 36. When the tool 10 is needed (as a penlight and/or as shears), the tool 10 is simply removed from the holster 36. The holster 36 may stay in place on the stethoscope 46.

It should be understood, of course, that the foregoing relates to exemplary embodiments of the invention and that modifications may be made without departing from the spirit and scope of the invention as set forth in the following claims.

What is claimed is:

1. A tool comprising:
a penlight;
shears attached to the penlight;
a holster for removably holding the penlight and shears;
a strap adapted to secure the holster to a stethoscope.

2. The tool of claim 1, wherein a first blade of the shears is affixed to the penlight and the second blade of the shears pivots relative to the first blade.

3. The tool of claim 1, further comprising a button, wherein the penlight has a lamp that is turned on during depression of the button.

4. The tool of claim 1, further comprising a slip resistant coating on an inside surface of the strap, the slip resistant coating adapted to prevent slipping of the holster when attached to the stethoscope.

5. The tool of claim 2, further comprising means for resiliently opening the second blade from the first blade.

6. The tool of claim 5, wherein the means includes an internal spring.

7. The tool of claim 5, further comprising a latch for holding the second blade closed against the first blade.

8. The tool of claim 1, further comprising first and second tabs formed on ends of the penlight.

9. The tool of claim 8, further comprising first and second slots on the holster, wherein the first and second tabs are adapted to removably fit into the first and second slots to secure the penlight to the holster.

10. The tool of claim 1, wherein the strap is adapted to be secured to the stethoscope with a hook and loop type fastener.

11. The tool of claim 1, further comprising a pressing surface disposed on the second blade, opposite a cutting surface of the second blade.

12. The tool of claim 11, further comprising an indent formed in the pressing surface.

13. A penlight/shears combination tool comprising:
a penlight/shears combination unit, the combination unit including a penlight, a first blade of shears attached to the penlight, and a second blade of shears pivotably attached to the penlight;
a holster for removably securing the penlight/shears combination unit;
a strap adapted to secure the holster to a stethoscope, wherein the strap has a slip resistant material on at least a portion of an inside surface thereof.

14. The penlight/shears combination tool of claim 13, further comprising means for resiliently opening the second blade from the first blade.

15. The penlight/shears combination tool of claim 13, further comprising a latch for holding the second blade closed against the first blade.

16. The penlight/shears combination tool of claim 13, further comprising:
first and second tabs formed on ends of the penlight; and
first and second slots on the holster, wherein the first and second tabs are adapted to removably fit into the first and second slots to secure the penlight to the holster.

17. The penlight/shears combination tool of claim 13, wherein the strap is adapted to be secured to the stethoscope with a hook and loop type fastener.

18. A medical tool comprising:
a stethoscope;
a holster removably attached to a tube of the stethoscope;
a penlight/shears combination unit removably attached to the holster, wherein the penlight/shears combination unit includes a penlight, a first blade of shears attached to the penlight, and a second blade of shears pivotably attached to the penlight.

19. The medical tool of claim 18, further comprising a slip resistant coating on an inside surface of the strap, the slip resistant coating adapted to prevent slipping of the holster when attached to the stethoscope.

20. The tool of claim 2, further comprising:
means for resiliently opening the second blade from the first blade; and
a latch for holding the second blade closed against the first blade.
